(19) United States
(12) Patent Application Publication
(10) Pub. No.: US 2015/0325252 A1
(43) Pub. Date: Nov. 12, 2015

(54) METHOD AND DEVICE FOR ELIMINATING NOISE, AND MOBILE TERMINAL

(71) Applicant: TENCENT TECHNOLOGY (SHENZHEN) COMPANY LIMITED, Shenzhen,GD (CN)

(72) Inventors: Weigang PENG, Shenzhen (CN); Bo WU, Shenzhen (CN); Xian HU, Shenzhen (CN); Hongfeng FU, Shenzhen (CN); Shaobo LI, Shenzhen (CN); Kui JIANG, Shenzhen (CN)

(21) Appl. No.: 14/410,602

(22) PCT Filed: Jun. 27, 2013
(86) PCT No.: PCT/CN2013/078130

§ 371 Date: Dec. 23, 2014

(30) Foreign Application Priority Data
Jun. 28, 2012 (CN) 201210217760.9

(51) Int. Cl. G10L 21/0208; G10L 19/018

(52) U.S. Cl. CPC G10L 21/0208; G10L 19/018

(57) ABSTRACT

A method and device for eliminating noise, and a mobile terminal. The method comprises: extracting, from the voice of a talker, an audio fingerprint of the talker voice in advance (101); and when the talker talks with an opposite listener, according to the audio fingerprint of the talker, extracting a voice which matches the audio fingerprint from the current talking voice, and sending to the opposite listener the voice which matches the audio fingerprint through a communication network (102).

### TECHNICAL FIELD

The present disclosure relates to computer technologies, and more particularly, to a method, apparatus and mobile terminal for eliminating noise.

### BACKGROUND

Along with the developments of mobile communication technologies, mobile terminals are used increasingly widely. When a user makes a call by using a mobile terminal, the communication quality is affected by background noise of surrounding environments. For example, when the user communicates with a friend by using a mobile phone, if the surrounding environment of the user is noisy, voice data transmitted by the user via the mobile phone is affected by the background noise, and voice data received by the friend includes the background noise, and thus the communication quality is reduced.

In conventional processing for increasing the communication quality, additional hardware, e.g. noise elimination hardware, is added into the mobile terminal. The noise elimination hardware includes a background noise elimination microphone, a noise elimination chip and a sounding device. The background noise elimination microphone is used to collect noise wave when a normal microphone of the mobile terminal is collecting voice data of the user. The noise elimination chip is used to generate a sound wave opposite to the noise wave collected by the background noise elimination microphone. The sounding device is used to send the sound wave opposite to the noise wave, so that the noise is counteracted and the communication quality is improved.

However, in the conventional processing for increasing the communication quality, the additional noise elimination hardware is added into the mobile terminal, which increases the hardware cost of the mobile terminal, especially for the mobile phone. In addition, the noise elimination hardware cannot eliminate the noise completely, and the noise which is not eliminated is transmitted to an opposite listener together with the voice data of the user. In this way, audio data transmitted by the user is large, and the transmission rate and quality of the audio data is affected. Moreover, enough distance is needed between the background noise elimination microphone and the normal microphone in the mobile terminal, which increases the difference of designing the mobile terminal.

### SUMMARY

The examples of the present disclosure provide a method, apparatus and mobile terminal for eliminating noise, so as to eliminate background noise during a communication process without adding hardware for eliminating noise into a mobile terminal.

A method for eliminating noise includes:

extracting an audio fingerprint of a talker from voice of the talker in advance;

when the talker talks with an opposite listener, extracting voice data matching with the audio fingerprint of the talker from current talking voice; and

sending the voice data matching with the audio fingerprint of the talker to the opposite listener through a communication network.

An apparatus for eliminating noise includes: storage and a processor for executing instructions stored in the storage, wherein the instructions comprise:

an extracting instruction, to extract an audio fingerprint of a talker from voice of the talker in advance;

a transmission instruction, when the talker talks with an opposite listener, to extract voice data matching with the audio fingerprint of the talker from current talking voice; and send the voice data matching with the audio fingerprint of the talker to the opposite listener through a communication network.

A mobile terminal for eliminating noise includes the above described apparatus for eliminating noise.

According to the technical solutions of the present disclosure, the audio fingerprint of the talker is extracted from the voice of the talker in advance, when the talker talks with the opposite listener, the voice data matching with the audio fingerprint of the talker is extracted from the current talking voice, and the voice data matching with the audio fingerprint of the talker is sent to the opposite listener through the communication network. By using the examples of the present disclosure, it is ensured that the voice received by the opposite listener is clear and is necessary for the communication, and thus the communication quality is increased.

Moreover, because only the actual voice of the talker is transmitted through the communication network, and the noise is not transmitted, the load of the communication network is reduced.

### BRIEF DESCRIPTION OF THE DRAWINGS

FIG. 1 is a schematic flowchart illustrating a method for eliminating noise according to various example of the present disclosure.

FIG. 2 is a schematic flowchart illustrating a method for eliminating noise according to various example of the present disclosure.

FIG. 3 is a schematic diagram illustrating an apparatus for eliminating noise according to various example of the present disclosure.

FIG. 4 is a schematic diagram illustrating an apparatus for eliminating noise according to various example of the present disclosure.

### DETAILED DESCRIPTION

In order to make the object, technical solution and merits of the present disclosure clearer, the present disclosure will be illustrated in detail hereinafter with reference to the accompanying drawings and specific examples.

Methods for eliminating noise provided by the examples of the present disclosure may be applied to various mobile terminals, e.g. mobile phones, or may be applied to fixed hardware device, e.g. personal computers. In the following examples, the mobile terminals are taken as examples.

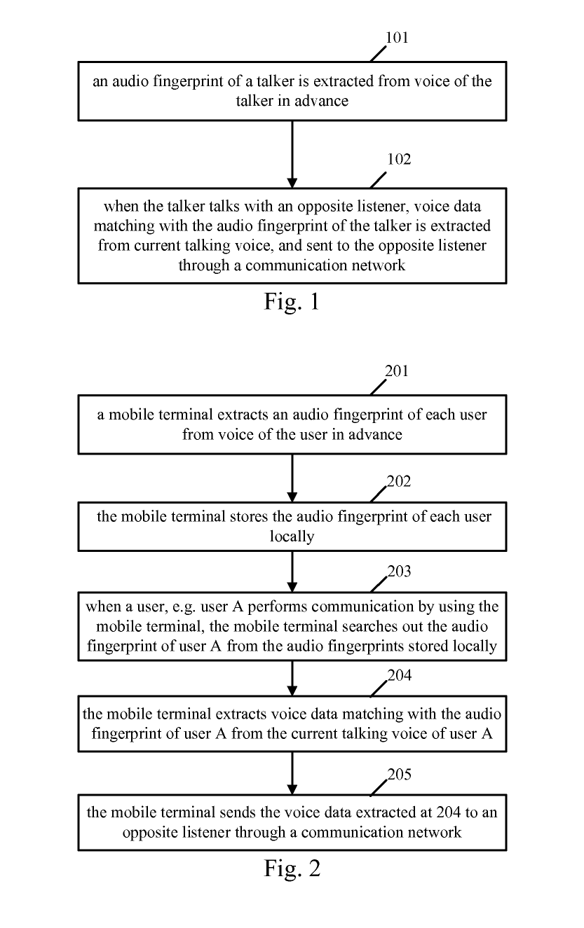

FIG. 1 is a schematic flowchart illustrating a method for eliminating noise according to various example of the present disclosure. As shown in FIG. 1, the method includes the following processing.

At 101, an audio fingerprint of a talker is extracted from voice of the talker in advance.

In an example, the audio fingerprint indicates voice attributes of the talker and may be used to identify the voice of the talker.

At 102, when the talker talks with an opposite listener, voice data matching with the audio fingerprint of the talker is extracted from current talking voice, and sent to the opposite listener through a communication network.

In an example, the current talking voice may include actual voice of the talker and noise which affects the actual voice of the talker.

When the surrounding environment of the talker is noisy, the current talking voice includes the noise and the actual voice of the talker. If the mobile terminal directly sends the current talking voice through the communication network, the opposite listener may receive both the noise and the actual voice of the talker, and the communication quality is bad. According to the examples of the present disclosure, before the current talking voice is sent through the communication network, the actual voice of the talker is extracted from the current talking voice, and only the extracted voice is sent through the communication network. Therefore, the opposite listener may receive the actual voice of the talker, which is clear and is necessary for the communication, and thus the communication quality is increased.

It should be noted that, the processing at 101 and 102 may be implemented via software installed in the mobile terminal.

FIG. 2 is a schematic flowchart illustrating a method for eliminating noise according to various example of the present disclosure. As shown in FIG. 2, the method includes the following processing.

At 201, a mobile terminal extracts an audio fingerprint of each user from voice of the user in advance.

In an example, the audio fingerprint indicates voice attributes of the user and may be used to identify the voice of the user.

In an example, when extracting the audio fingerprint of the user from the voice of the user, the mobile terminal divides a voice signal of the user into multiple frames overlapped with at least one adjacent frame, performs a character operation for each frame to obtain a result, maps the result as a piece of data by using a classifier mode, and takes the multiple pieces of data as the audio fingerprint.

In an example, the voice signal of the user may be divided into multiple frames by using the following modes.

In the first mode, starting from different time points, the voice signal of the user is divided into multiple frames overlapped with at least one adjacent frame according to a preset time interval. In the second mode, starting from different frequencies, the voice signal of the user is divided into multiple frames overlapped with at least one adjacent frame according to a preset frequency interval.

For example, the preset time interval is 1 ms, the first frame divided from the voice signal of the user starts from 0 ms and the length of the first frame is 1 ms, the second frame divided from the voice signal of the user starts from 0.5 ms and the length of the second frame is 1 ms, the third frame divided from the voice signal of the user starts from 1 ms and the length of the third frame is 1 ms, the fourth frame divided from the voice signal of the user starts from 1.5 ms and the length of the fourth frame is 1 ms, and so on. In this way, the multiple frames divided from the voice signal of the user are overlapped with at least one adjacent frame.

In an example, the character operation performed for the frame may include any one of a Fast Fourier Transform (FFT), a Wavelet Transform (WT), an operation for obtaining a Mel Frequency Cepstrum Coefficient (MFCC), an operation for obtaining spectral smoothness, an operation for obtaining sharpness, a linear predictive coding (LPC).

The classifier mode may be a conventional Hidden Markov Model or quantification technique, and conventional modes may be used to map the result to the piece of data by using the Hidden Markov Model or quantification technique.

At 202, the mobile terminal stores the audio fingerprint of each user locally.

At 203, when a user, e.g. user A performs communication by using the mobile terminal, the mobile terminal searches out the audio fingerprint of user A from the audio fingerprints stored locally.

When the surrounding environment of user A is noisy, the current talking voice of user A includes the noise and the actual voice of user A. The noise may be background noise surround user A.

At 204, the mobile terminal extracts voice data matching with the audio fingerprint of user A from the current talking voice of user A.

In an example, a target voice forecasting mode is used to forecast the voice data matching with the audio fingerprint of user A from the current talking voice of user A. The forecasted voice data is extract from the current talking voice by using secondary positioning for a target voice in a time-frequency domain, and the extracted voice data is taken as the voice data matching with the audio fingerprint of user A.

The target voice forecasting mode and the secondary positioning for the target voice in the time-frequency domain are similar to the conventional technologies, and are not described herein. At 205, the mobile terminal sends the voice data extracted at 204 to an opposite listener through a communication network. According to the above processing, the opposite listener may listen to the actual voice of user A, so that the communication quality between user A and the opposite listener is ensured. Moreover, because only the actual voice of user A is transmitted through the communication network, the load of the communication network is reduced.

Besides the above described methods, the embodiments of the present disclosure also provide an apparatus for eliminated noise,

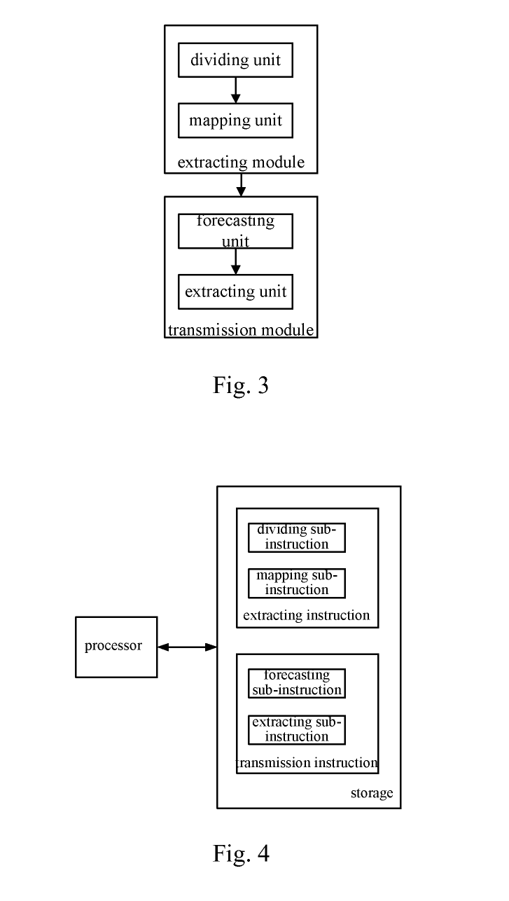

FIG. 3 is a schematic diagram illustrating an apparatus for eliminating noise according to various example of the present disclosure. As shown in FIG. 3, the apparatus includes an extracting module and a transmission module.

The extracting module is to extract an audio fingerprint of a talker from voice of the talker in advance.

The transmission module is to, when the talker talks with an opposite listener, extract voice data matching with the audio fingerprint of the talker from current talking voice, and send the voice data matching with the audio fingerprint of the talker to the opposite listener through a communication network. The current talking voice may include actual voice of the talker and noise which affects the actual voice of the talker.

In an example, as shown in FIG. 3, the extracting module includes a dividing unit and a mapping unit.

The dividing unit is to divide a voice signal of the talker into multiple frames overlapped with at least one adjacent frame.

The mapping unit is to perform a character operation for each frame to obtain a result, map the result as a piece of data by using a classifier mode, and take the multiple pieces of data as the audio fingerprint.

In an example, when the dividing unit divides the voice signal of the talker into multiple frames, the following modes may be used.

In the first mode, starting from different time points, the voice signal of the talker is divided into multiple frames overlapped with at least one adjacent frame according to a preset time interval. In the second mode, starting from different frequencies, the voice signal of the talker is divided into multiple frames overlapped with at least one adjacent frame according to a preset frequency interval.

In an example, the transmission module extracts the voice data matching with the audio fingerprint of the talker from the current talking voice by using a forecasting unit and an extracting unit.

The forecasting unit is to forecast the voice data matching with the audio fingerprint of the talker from the current talking voice by using a target voice forecasting mode.

The extracting unit is to extract the forecasted voice data from the current talking voice by using secondary positioning for a target voice in a time-frequency domain, and take the extracted voice data as the voice data matching with the audio fingerprint of the talker.

FIG. 4 is a schematic diagram illustrating an apparatus for eliminating noise according to various example of the present disclosure. As shown in FIG. 4, the apparatus at least includes storage and a processor which may communicate with the storage. The storage stores an extracting instruction and a transmission instruction, which may be executed by the processor.

The extracting instruction is to extract an audio fingerprint of a talker from voice of the talker in advance.

The transmission instruction is to, when the talker talks with an opposite listener, extract voice data matching with the audio fingerprint of the talker from current talking voice, and send the voice data matching with the audio fingerprint of the talker to the opposite listener through a communication network. The current talking voice may include actual voice of the talker and noise which affects the actual voice of the talker.

In an example, the extracting instruction includes a dividing sub-instruction and a mapping sub-instruction.

The dividing sub-instruction is to divide a voice signal of the talker into multiple frames overlapped with at least one adjacent frame.

The mapping sub-instruction is to perform a character operation for each frame to obtain a result, map the result as a piece of data by using a classifier mode, and take the multiple pieces of data as the audio fingerprint.

In an example, when dividing the voice signal of the talker into multiple frames, the dividing sub-instruction is to, starting from different time points, divide the voice signal of the talker into multiple frames overlapped with at least one adjacent frame according to a preset time interval; or starting from different frequencies, divide the voice signal of the talker into multiple frames overlapped with at least one adjacent frame according to a preset frequency interval.

In an example, the transmission module extracts the voice data matching with the audio fingerprint of the talker from the current talking voice by using a forecasting sub-instruction and an extracting sub-instruction.

The forecasting sub-instruction is to forecast the voice data matching with the audio fingerprint of the talker from the current talking voice by using a target voice forecasting mode.

The extracting sub-instruction is to extract the forecasted voice data from the current talking voice by using secondary positioning for a target voice in a time-frequency domain, and take the extracted voice data as the voice data matching with the audio fingerprint of the talker.

The embodiments of the present disclosure also provide a mobile terminal. The mobile terminal includes the apparatus shown in FIG. 3 or FIG. 4.

According to the technical solutions of the present disclosure, the audio fingerprint of the talker is extracted from the voice of the talker in advance, when the talker talks with the opposite listener, the voice data matching with the audio fingerprint of the talker is extracted from the current talking voice, and the voice data matching with the audio fingerprint of the talker is sent to the opposite listener through the communication network. The current talking voice may include actual voice of the talker and noise which affects the actual voice of the talker. By using the examples of the present disclosure, it is ensured that the voice received by the opposite listener is clear and is necessary for the communication, and thus the communication quality is increased.

Moreover, because only the actual voice of the talker is transmitted through the communication network, and the noise is not transmitted, the load of the communication network is reduced.

The foregoing is only preferred examples of the present invention and is not used to limit the protection scope of the present invention. Any modification, equivalent substitution and improvement without departing from the spirit and principle of the present invention are within the protection scope of the present invention.

1. A method for eliminating noise, comprising:
extracting an audio fingerprint of a talker from voice of the talker in advance;
when the talker talks with an opposite listener, extracting voice data matching with the audio fingerprint of the talker from current talking voice; and
sending the voice data matching with the audio fingerprint of the talker to the opposite listener through a communication network.

2. The method of claim 1, further comprising:
storing at least one audio fingerprint extracted in advance;
wherein extracting the voice data matching with the audio fingerprint of the talker from the current talking voice comprises:
extracting the voice data matching with the audio fingerprint of the talker from the current talking voice, after obtaining the audio fingerprint of the talker from the at least one audio fingerprint stored.

3. The method of claim 1, wherein extracting the voice data matching with the audio fingerprint of the talker from the current talking voice comprises:
dividing a voice signal of the talker into multiple frames overlapped with at least one adjacent frame;
performing a character operation for each frame to obtain a result, mapping the result as a piece of data by using a classifier mode, and taking the multiple pieces of data as the audio fingerprint.

4. The method of claim 3, wherein the character operation comprises at least one of a Fast Fourier Transform (FFT), a Wavelet Transform (WT), an operation for obtaining Mel Frequency Cepstrum Coefficient (MFCC), an operation for obtaining spectral smoothness, an operation for obtaining sharpness, a linear predictive coding (LPC).

5. The method of claim 3, wherein dividing the voice signal of the talker into multiple frames overlapped with at least one adjacent frame; comprises:
starting from different time points, dividing the voice signal of the talker into multiple frames overlapped with at least one adjacent frame according to a preset time interval; or
starting from different frequencies, dividing the voice signal of the talker into multiple frames overlapped with at least one adjacent frame according to a preset frequency interval.

6. The method of claim 3, wherein extracting the voice data matching with the audio fingerprint of the talker from the current talking voice comprises:
forecasting the voice data matching with the audio fingerprint of the talker from the current talking voice by using a target voice forecasting mode; and
extracting the forecasted voice data from the current talking voice by using secondary positioning for a target voice in a time-frequency domain; and taking the extracted voice data as the voice data matching with the audio fingerprint of the talker.

7. An apparatus for eliminating noise, comprising: storage and a processor for executing instructions stored in the storage, wherein the instructions comprise:
an extracting instruction, to extract an audio fingerprint of a talker from voice of the talker in advance;
a transmission instruction, when the talker talks with an opposite listener, to extract voice data matching with the audio fingerprint of the talker from current talking voice;
and send the voice data matching with the audio fingerprint of the talker to the opposite listener through a communication network.

8. The apparatus of claim 7, wherein the extracting instruction comprises:
a dividing sub-instruction, to divide a voice signal of the talker into multiple frames overlapped with at least one adjacent frame;
a mapping sub-instruction, to perform a character operation for each frame to obtain a result, map the result as a piece of data by using a classifier mode, and take the multiple pieces of data as the audio fingerprint.

9. The apparatus of claim 8, wherein the dividing sub-instruction is to
starting from different time points, divide the voice signal of the talker into multiple frames overlapped with at least one adjacent frame according to a preset time interval; or,
starting from different frequencies, divide the voice signal of the talker into multiple frames overlapped with at least one adjacent frame according to a preset frequency interval.

10. The apparatus of claim 7, wherein the transmission instruction is to extract the voice data matching with the audio fingerprint of the talker from the current talking voice by using a forecasting sub-instruction and an extracting sub-instruction;
the forecasting sub-instruction is to forecast the voice data matching with the audio fingerprint of the talker from the current talking voice by using a target voice forecasting mode;
the extracting sub-instruction is to extract the forecasted voice data from the current talking voice by using secondary positioning for a target voice in a time-frequency domain, and take the extracted voice data as the voice data matching with the audio fingerprint of the talker.

11. A mobile terminal, comprising an apparatus, wherein the apparatus comprises storage and a processor for executing instructions stored in the storage, the instructions comprise:
an extracting instruction, to extract an audio fingerprint of a talker from voice of the talker in advance;
a transmission instruction, when the talker talks with an opposite listener, to extract voice data matching with the audio fingerprint of the talker from current talking voice;
and send the voice data matching with the audio fingerprint of the talker to the opposite listener through a communication network.

12. The mobile terminal of claim 11, wherein the extracting instruction comprises:
a dividing sub-instruction, to divide a voice signal of the talker into multiple frames overlapped with at least one adjacent frame;
a mapping sub-instruction, to perform a character operation for each frame to obtain a result, map the result as a piece of data by using a classifier mode, and take the multiple pieces of data as the audio fingerprint.

13. The mobile terminal of claim 12, wherein the dividing sub-instruction is to
starting from different time points, divide the voice signal of the talker into multiple frames overlapped with at least one adjacent frame according to a preset time interval; or,
starting from different frequencies, divide the voice signal of the talker into multiple frames overlapped with at least one adjacent frame according to a preset frequency interval.

14. The mobile terminal of claim 11, wherein the transmission instruction is to extract the voice data matching with the audio fingerprint of the talker from the current talking voice by using a forecasting sub-instruction and an extracting sub-instruction;
the forecasting sub-instruction is to forecast the voice data matching with the audio fingerprint of the talker from the current talking voice by using a target voice forecasting mode;
the extracting sub-instruction is to extract the forecasted voice data from the current talking voice by using secondary positioning for a target voice in a time-frequency domain, and take the extracted voice data as the voice data matching with the audio fingerprint of the talker.
